(19) United States
(12) Patent Application Publication
(10) Pub. No.: US 2009/0035492 A1
(43) Pub. Date: Feb. 5, 2009

(54) Laser marking label

(75) Inventors: Tsuneyuki Amano, Osaka (JP); Takashi Imoto, Osaka (JP); Rie Nakahira, Osaka (JP)

Correspondence Address: BIRCH STEWART KOLASCH & BIRCH, PO BOX 747, FALLS CHURCH, VA, 22040-0747, US

(73) Assignee: NITTO DENKO CORPORATION

(21) Appl. No.: 12/219,052

(22) Filed: Jul. 15, 2008

(30) Foreign Application Priority Data
Aug. 1, 2007 (JP) 2007-201227

(51) Int. Cl. B41M 5/40

(52) U.S. Cl. 428/32.52

(57) ABSTRACT

The present invention relates to a laser marking label for forming patterns by a process including the step of selectively destroying a recording layer with a laser beam and exposing lower layers, wherein the laser marking label contains at least a recording layer, a backing layer, a ground layer, a shielding layer, and an adhesive layer, in this order, wherein each of the layers is directly or indirectly laminated. According to the laser marking label of the present invention, patterns of a workpiece or an opening part can be covered for the designing property and prevention of erroneous operation of an optical sensor, and the label can also serve as a display, in other words, excellent shielding ability in both line image portions and non-line image portions can be provided. Also at the same time, a display of white line images on a black background, sufficient durability and sufficient resolution can be realized.

### BACKGROUND OF THE INVENTION

1. Field of the Invention

The present invention relates to a display label to be recorded with laser beams.

2. Discussion of the Related Art

As a method for displaying information on parts or manufactured articles, a method of directly printing the information, a method of stamping the information, a method of affixing a label, or the like has been known. The method of directly printing the information can only used under limited conditions due to a limited combination of a material for a workpiece and a material for a printed ink, difficulty in printing the information on workpieces having various shapes, and difficulty in printing variable information. As the method of stamping the information, a method of directly stamping the information on a workpiece with laser beams, which is a so-called “laser marking” in recent years has been realized; however, this method cannot be used in a case where a workpiece is not desired to be damaged in view of a disadvantage in strength, external appearance or the like, or in a case where it is desired to replace the displayed information. Therefore, the method of affixing a label has been most generally well employed (Japanese Patent Laid-Open No. 2006-206910).

As a method of patterning to a label, various printing methods have been employed. A thermal transfer method has been widely spread, from the viewpoint of ability of publishing on-the-spot, easy maintenance, relatively inexpensive printing machine, and the like. However, disadvantages of the thermal transfer method include insufficient durability, undesired resolution, especially resolution according to two-dimensional codes, disadvantage in providing white line image patterns on a black background or the like. From the above, a method of printing the information to a label by means of laser marking has also begun to be widely used.

On the other hand, there is a shielding tape for covering patterns of a workpiece or an opening part because of the designing property and prevention of erroneous operation of an optical sensor, and there is a need for a shielding label also serving as a display. The thermal transfer method is particularly disadvantageous in the display of white line images on a black background, has insufficient durability and insufficient resolution in two-dimensional codes or the like having small cell sizes. Therefore, a laser marking label is more favorably used, but a label having sufficient shielding ability has not yet been found.

An object of the present invention is to provide a laser marking label capable of covering patterns of a workpiece or an opening part for the designing property and prevention of erroneous operation of an optical sensor, and also serving as a display, in other words, a laser marking label having excellent shielding ability in both line image portions and non-line image portions.

These and other objects of the present invention will be apparent from the following description.

### SUMMARY OF THE INVENTION

Specifically, the present invention relates to:
(1) a laser marking label for forming patterns by a process including the step of selectively destroying a recording layer with a laser beam and exposing lower layers, wherein the laser marking label contains at least a recording layer, a backing layer, a ground layer, a shielding layer, and an adhesive layer, in this order, wherein each of the layers is directly or indirectly laminated;
(2) a laser marking label for forming patterns by a process including the step of selectively destroying a recording layer with a laser beam and exposing lower layers, wherein the laser marking label contains at least a recording layer, a backing and ground layer, a shielding layer, and an adhesive layer, in this order, wherein each of the layers is directly or indirectly laminated; and
(3) a laser marking label for forming patterns by a process including the step of selectively destroying a recording layer with a laser beam and exposing lower layers, wherein the laser marking label contains at least a recording layer, a backing layer, a ground and shielding layer, and an adhesive layer, in this order, wherein each of the layers is directly or indirectly laminated.

According to the laser marking label of the present invention, patterns of a workpiece or an opening part can be covered for the designing property and prevention of erroneous operation of an optical sensor, and the label can also serve as a display, in other words, excellent shielding ability in both line image portions and non-line image portions can be provided. Also at the same time, a display of white line images on a black background, sufficient durability and sufficient resolution can be realized.

### BRIEF DESCRIPTION OF THE DRAWINGS

FIG. 1 is a cross-sectional schematic view of a laser marking label showing one embodiment of the present invention.

FIG. 2 is a cross-sectional schematic view of a laser marking label showing another embodiment of the present invention.

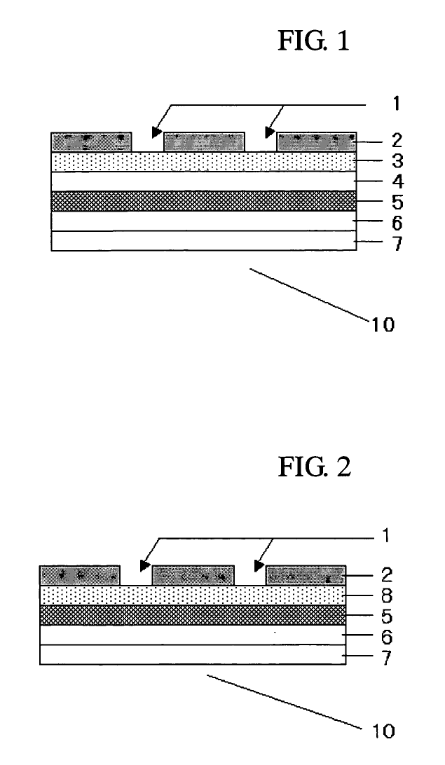

The explanation of the numerals in FIGS. 1 and 2 are as follows:

1 is a line image portion, 2 a recording layer, 3 a backing layer, 4 a ground layer, 5 a shielding layer, 6 an adhesive layer, 7 a release liner, 8 a backing and ground layer, and 10 a laser marking label.

### DETAILED DESCRIPTION OF THE INVENTION

### Laser Marking Label

### 1. Recording Layer

It is preferable that a recording layer is a black background (black layer) or a white background (white layer) for the counterpart of white line images or black line images, respectively. For example, in a case where white line images are recorded on a black background, the recording layer would be a black layer. Here, the phrase “white line images or black line images” as used herein refers to those displayed by lower layers after destroying the recording layer with laser marking. The material to be used in the recording layer includes acrylic resins, polyester resins, vinyl chloride-vinyl acetate copolymers, polyurethane resins, epoxy resins, alkyd resins, cyclized rubbers, chlorinated polyolefin resins, and the like. Further, the recording layer is preferably formed on a material used for the recording layer by using a known printing or coating method, or directly formed on another layer (for example, a backing layer), and the recording layer is more preferably directly formed on another layer. The method for forming a recording layer is preferably black printing, white printing or white coating, and black or white gravure printing is more preferred. As the material used in the printing or coating, for example, a gravure ink, or the like is suitably used. The recording layer has a thickness of preferably from 0.1 to 10 μm, more preferably from 0.3 to 5 μm, and even more preferably from 0.5 to 2 μm. When the recording layer has a thickness of less than 0.1 μm, image contrast is lowered, and image defects such as pinholes are likely to be admixed. When the recording layer has a thickness exceeding 10 μm, the energy required for laser marking becomes undesirably large, so that sharpness at the edge of the line images is lowered, thereby lowering the resolution of marking.

### 2. Backing Layer

A backing layer is desirably made of a material having strength or rigidity, or has a desired thickness as a backing for a label. The material includes, paper, polyethylene terephthalate, polyethylene naphthalate, polypropylene, polyethylene, polystyrene, and the like. Among them, polyethylene terephthalate is more desirable. The backing layer has a thickness of preferably from 5 to 500 μm, more preferably from 10 to 200 μm, and even more preferably from 20 to 100 μm. When the backing layer has a thickness of less than 5 μm, rigidity and strength of the backing layer become small, thereby making it difficult to handle as a label. Also, for example, upon destroying the recording layer (black layer) with laser beams, a backing layer, and even lower layers a ground layer (white layer) and a shielding layer are damaged, so that high-contrast, black-and-white images cannot be obtained, and that sufficient shielding ability cannot be obtained. When the backing layer has a thickness of greater than 500 μm, rigidity as a label becomes too large, so that an edge portion is risen away from the workpiece due to repulsive forces in a case of affixing the label to a curve portion, that the step height upon pasting the label is too large, or that the label cannot be pasted on a workpiece having a limited thickness.

The backing layer is preferably transparent, from the viewpoint of arbitrarily selecting a colorant (for example, an ink) of a ground layer which would be a color of the background, and a transparent PET film having a thickness of preferably from 12 to 100 μm, and more preferably from 25 to 75 μm, is preferably used.

### 3. Ground Layer

In a case where a recording layer is a black background (black layer), it is preferable that a ground layer is a white layer, and on the other hand, in a case where a recording layer is a white background (white layer), it is preferable that a ground layer is a black layer. It is preferable that the material to be used in the ground layer is the same as that of the recording layer. The ground layer is formed on the material for a ground layer using a known printing or coating method, or directly formed on another layer (for example, a backing layer), and the ground layer is more preferably directly formed on another layer. The method for forming a ground layer is preferably black printing or white printing, and black or white gravure printing is more preferred. The ground layer has a thickness of preferably from 0.5 to 20 μm, more preferably from 1 to 15 μm, and even more preferably from 3 to 10 μm. When the ground layer has a thickness of less than 0.5 μm, image contrast is lowered, and image defects such as pinholes are likely to be admixed. When the ground layer has a thickness exceeding 20 μm, it becomes costly.

In addition, a backing layer may also serve as a ground layer, from the viewpoint of the reduction of production steps (also referred to herein as “backing and ground layer”). It is preferable that the material for the backing and ground layer is the same as that of the backing layer. In a case where the recording layer is a black background (black layer) with white line images, a white PET film kneaded with a pigment (film prepared by kneading with a white pigment such as titanium oxide), the white PET film having a thickness of preferably from 25 to 200 μm, and more preferably from 50 to 100 μm may be used as a backing and ground layer. In a case where the recording layer is a white background (white layer) with black line images, a black PET film kneaded with a pigment, the black PET film having a thickness of preferably from 25 to 200 μm, and more preferably from 50 to 100 μm, may be used as a backing and ground layer.

It is desired that the backing layer or the backing and ground layer has a thickness of preferably 5 times or more, and more preferably 10 times or more that of the recording layer, and a thickness of preferably 200 times or less, and more preferably 100 times or less that of the recording layer. When the thickness is less than 5 times that of the recording layer, for example, a backing layer is 5 μm to a recording layer of 2 μm (2.5 times), if a recording layer is subjected to laser marking stably with destroying energy, a backing layer is also provided with some open holes, so that lower layers are also likely to be further damaged in many cases. In addition, when the thickness is greater than 200 times the thickness of the recording layer, the backing layer is sufficiently thick to a recording layer, so that there is no disadvantage such as open holes; however, the backing layer is unnecessarily thick, so that it is less easily pasted to a curved side, merely increasing the costs.

### 4. Shielding Layer

In general, a white layer or a black layer alone serving as a ground layer does not give sufficient shielding ability. Therefore, in the present invention, a shielding layer is laminated thereto. As the shielding layer, for example, a silver ink coating layer using a pigment having high shielding ability such as a metal powder pigment, including for example, aluminum, stainless steel, and nickel, an aluminum vapor deposition layer, or the like is preferably used. In the case of the former, a known printing or coating method is preferably used in the formation of the shielding layer, among which screen printing is preferred. In the case of printing method, a shielding layer has a thickness of preferably from 0.5 to 30μm, more preferably from 1 to 20 μm, and even more preferably from 1.5 to 10 μm. When the shielding layer has a thickness of less than 0.5 μm, sufficient shielding ability cannot be obtained. When the shielding layer has a thickness of greater than 30 μm, shielding ability is sufficient; however, it not only is costly but also causes disadvantages such as cracks of the film. In a case of aluminum vapor deposition, a shielding layer has a thickness of preferably 100 nm or less, and more preferably from 30 to 50 nm. In addition, in a case where the backing and ground layer is a white PET film or a black PET film, it is preferable that the shielding layer is an aluminum vapor deposition layer, from the viewpoint of productivity.

Alternatively, a ground layer may also serve as a shielding layer (also referred to herein as “ground and shielding layer”), from the viewpoint of productivity. It is preferable that the material for the ground and shielding layer is the same as that of the recording layer. The ground and shielding layer is formed on the material for a ground and shielding layer using the same printing or coating method as the shielding layer, or directly formed on another layer (for example, a backing layer), and the ground and shielding layer is more preferably directly formed on another layer. The ground and shielding layer is preferably an aluminum vapor deposition layer or a silver ink coating layer, and a silver ink coating layer is more preferred. However, in a case where silver line images are formed on a black background, it is even more desired that the ground layer and the shielding layer are separately provided because it is hardly likely to obtain contrast by the influences of the mirror reflections, especially in read-off of bar codes or two-dimensional codes with a scanner or a CCD camera. The ground and shielding layer has a thickness of preferably from 0.5 to 50 μm, more preferably from 1 to 30 μm, and even more preferably from 1.5 to 20 μm. When the ground and shielding layer has a thickness of less than 0.5 μm, a sufficient shielding ability cannot be obtained. On the other hand, when the ground and shielding layer has a thickness of greater than 50 μm, sufficient shielding ability is obtained; however, it not only is costly but causes disadvantages such as cracks on a film.

### 5. Adhesive Layer and Release Liner

It is desirable to use a known adhesive layer and a known release liner.

In one embodiment of the present invention, as shown in FIG. 1, a laser marking label 10 contains at least a recording layer 2, a backing layer 3, a ground layer 4, a shielding layer 5, an adhesive layer 6, and a release liner 7. In another embodiment of the present invention, as shown in FIG. 2, a laser marking label 10 contains at least a recording layer 2, a backing and ground layer 8, a shielding layer 5, an adhesive layer 6, and a release liner 7. In still another embodiment of the present invention, a laser marking label contains at least a recording layer, a backing layer, a ground and shielding layer, an adhesive layer, and a release liner. In addition, each of the above layers is directly or indirectly laminated in this order, and other layers than the above may be optionally formed thereon.

### 6. Method for Producing Laser Marking Label

The laser marking label of the present invention can be produced by laminating each of the layers on a plastic film, which is a substrate serving, for example, as a backing layer or a backing and ground layer, by means of gravure printing, screen printing, coating method, aluminum vapor deposition, lamination, or the like.

### 7. Method for Laser Marking

The recording layer thus formed on the laser marking label is irradiated with laser beams, thereby marking the irradiated portions. The amount of energy of the laser to be irradiated is not particularly limited, and it is appropriate that the irradiated energy range is preferably from 2 to 50 J/cm², and more preferably from 5 to 20 J/cm², in consideration of the risk of destroying the lower layers. In addition, the irradiating laser is preferably a pulsing laser or a scanning laser, and the kinds of the lasers may be any one of gas lasers, excimer lasers, and semiconductor lasers. Specific examples thereof include carbon dioxide gas lasers, mixed gas lasers, YAG lasers, ruby lasers, and the like.

A method of partly irradiating laser beams to a desired shape includes a method including the step of irradiating laser beams to a recording layer via a metal mask, thereby irradiating laser beams to a recording layer corresponding to a shape of a void of the mask metal; a method including the steps of inputting an intended desired shape into a computer, and irradiating laser beams according to the shape in the manner of a so-called “writing or drawing in a single-stroke,” and the like.

### 8. Method for Evaluation of Shielding Ability

A recorded laser marking label previously subjected to irradiation with laser beams to a recording layer of a laser marking label is placed before a light source, and whether or not light is leaked from the light source is visually observed. As the light source, a light table, a fluorescent lamp, a flashlight, a photographing light provided on a cellphone, or the like can be utilized.

### EXAMPLES

### Example 1

As to both of the sides of a transparent PET film (TORAY, Lumirror S10, thickness: 50μm) serving as a backing layer, one side of the transparent PET film was provided with a recording layer formed in a thickness of 2 μm by means of gravure printing (manufactured by TOSHIBA MACHINE CO., LTD.) with a gravure ink black (NB-300, manufactured by DAINICHISEIKA COLOR & CHEMICALS MFG. CO., LTD.); and the other side of the transparent PET film was provided with a ground layer formed in a thickness of 2 μm by means of gravure printing with a gravure ink white (NB-300, manufactured by DAINICHISEIKA COLOR & CHEMICALS MFG. CO., LTD.), and further with a shielding layer formed in a thickness of 10 μm by means of screen printing (manufactured by NEWLONG SEIMITSU KOGYO CO., LTD.) with a commercially available screen ink silver on a ground layer side, and then as an adhesive layer and a release liner an adhesive (acrylic resin, thickness: 50 μm)/separator (PET, thickness: 75 μm) (manufactured by NITTO DENKO CORPORATION, both sides, T LA-50) on a shielding layer side is pasted, thereby producing a laser marking label. Using this laser marking label, two-dimensional codes having a cell size of 120 μm were printed under the irradiation conditions for laser beams to this laser marking label at 10 J/cm² using Laser Marker MD-V9610 manufactured by KEYENCE. Here, the shielding ability was confirmed by placing the printed laser marking label before a light source (tracing table (ARTY PRO), manufactured by I-C INC.), and visually examining whether or not light is leaked therefrom.

### Example 2

The same procedures as in Example 1 were carried out except that as to both of the sides of a white PET film (TORAY, Lumirror E20, thickness: 38 μm) serving as a backing and ground layer, one side of the white PET film was provided with a recording layer formed in a thickness of 2 μm by means of gravure printing with a gravure ink black (FineStar, manufactured by TOYO INK MFG. CO., LTD.), and that the other side of the white PET film was provided with a shielding layer formed in a thickness of 50 nm by means of aluminum vapor deposition (winding-up vacuum vapor deposition apparatus, using a product manufactured by ULVAC, Inc.).

### Example 3

The same procedures as in Example 1 were carried out except that as to both of the sides of a transparent PET film (TORAY, Lumirror S10, thickness: 50 μm) serving as a backing layer, one side of the transparent PET film was provided with a recording layer formed in a thickness of 2 μm by means of gravure printing with a gravure ink white (NB-300, manufactured by DAINICHISEIKA COLOR & CHEMICALS MFG. CO., LTD.), and that the other side of the transparent PET film was provided with a ground layer formed in a thickness of 2 μm by means of gravure printing with a gravure ink black (NB-300, manufactured by DAINICHISEIKA COLOR & CHEMICALS MFG. CO., LTD.), and further with a shielding layer formed in a thickness of 50 nm by means of aluminum vapor deposition on a ground layer side.

### Example 4

The same procedures as in Example 1 were carried out except that as to both of the sides of a black PET film (TORAY, Lumirror X30, thickness: 38 μm) serving as a backing and ground layer, one side of the black PET film was provided with a recording layer formed in a thickness of 3 μm by means of gravure printing with a gravure ink white (FineStar, manufactured by TOYO INK), and that the other side of the black PET film was provided with a shielding layer formed in a thickness of 50 nm by means of aluminum vapor deposition.

### Example 5

The same procedures as in Example 1 were carried out except that as to both of the sides of a transparent PET film (TORAY, Lumirror S10, thickness: 75 μm) serving as a backing layer, one side of the transparent PET film was provided with a recording layer formed in a thickness of 5 μm by means of gravure printing with a gravure ink black (NB-300, manufactured by DAINICHISEIKA COLOR & CHEMICALS MFG. CO., LTD.), and that the other side of the transparent PET film was provided with a ground and shielding layer formed in a thickness of 15 μm by means of screen printing with a commercially available screen ink silver using a product manufactured by NEWLONG SEIMITSU KOGYO CO., LTD.

### Comparative Example 1

The same procedures as in Example 1 were carried out except that a shielding layer was not formed.

### Comparative Example 2

The same procedures as in Example 2 were carried out except that a shielding layer was not formed.

### Comparative Example 3

The same procedures as in Example 4 were carried out except that a shielding layer was not formed.

The evaluation results of the shielding ability obtained in each of Examples 1 to 5 and Comparative Examples 1 to 3 are shown in Table 1.

TABLE 1

| No. | Shielding Ability |
|---|---|
| Ex. 1 | ◯ |
| Ex. 2 | ◯ |
| Ex. 3 | ◯ |
| Ex. 4 | ◯ |
| Ex. 5 | ◯ |
| Comp. | X |
| Ex. 1 | |
| Comp. | X |
| Ex. 2 | |
| Comp. | X |
| Ex. 3 | |

Evaluation Criteria:

◯: Transmittance of light is not observed visually.

×: Transmittance of light is observed visually.

From Table 1, Examples 1 to 5 show excellent shielding ability. Also, at the same time, Examples 1 to 5 show clear display of white line images on black background, sufficient durability, and sufficient resolution.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A laser marking label for forming patterns by a process comprising selectively destroying a recording layer with a laser beam and exposing lower layers, wherein the laser marking label comprises at least a recording layer, a backing layer, a ground layer, a shielding layer, and an adhesive layer, in this order, wherein each of the layers is directly or indirectly laminated.

2. A laser marking label for forming patterns by a process comprising selectively destroying a recording layer with a laser beam and exposing lower layers, wherein the laser marking label comprises at least a recording layer, a backing and ground layer, a shielding layer, and an adhesive layer, in this order, wherein each of the layers is directly or indirectly laminated.

3. A laser marking label for forming patterns by a process comprising selectively destroying a recording layer with a laser beam and exposing lower layers, wherein the laser marking label comprises at least a recording layer, a backing layer, a ground and shielding layer, and an adhesive layer, in this order, wherein each of the layers is directly or indirectly laminated.

4. The laser marking label according to any one of claims 1 to 3, wherein the backing layer or the backing and ground layer has a thickness of 5 times or more that of the recording layer.

5. The laser marking label according to any one of claims 1 to 3, wherein the shielding layer or the ground and shielding layer is made of an aluminum vapor deposition layer or a silver ink coating layer.
